(19) United States
(12) Patent Application Publication
(10) Pub. No.: US 2008/0028763 A1
(43) Pub. Date: Feb. 7, 2008

(54) Thermal management system with thrust recovery for a gas turbine engine fan nacelle assembly

(75) Inventors: Frederick M. Schwarz, Glastonbury, CT (US); Mikhail B. Gorbounov, South Windsor, CT (US)

Correspondence Address: CARLSON, GASKEY & OLDS/PRATT & WHITNEY, 400 WEST MAPLE ROAD, SUITE 350, BIRMINGHAM, MI, 48009, US

(73) Assignee: United Technologies Corporation

(21) Appl. No.: 11/498,848

(22) Filed: Aug. 3, 2006

(51) Int. Cl. F02K 1/00

(52) U.S. Cl. 60/771

(57) ABSTRACT

A thermal management system locates a separate engine heat exchanger and generator heat exchanger into an engine nacelle pylon that is split to provide independent control of both a generator cooling circuit and an engine cooling circuit. A variable exhaust nozzle is provided downstream of each heat exchanger as each has different thermal and heat rejection requirements such that intake air is minimized and maximum thrust is produced in response to the current generator load and engine heat rejection.

### BACKGROUND OF THE INVENTION

The present invention relates to a thermal management system for a gas turbine engine, and more particularly to a nacelle pylon split by a bulkhead which provides for independent thermal control of both a generator heat exchanger circuit and an engine heat exchanger circuit as well as utilizing the rejected heat therefrom to increase thrust.

Thermal management systems for a turbofan engine and associated equipment, such as an integrated drive generator, utilize a pressurized lubricant such as an oil, to lubricate, cool and clean the engine main bearings, gear box gears, and the like. During usage, the lubricant receives thermal energy.

The heat of the lubricants in such systems has increased due to the use of larger electrical generators for increased electrical power production and increased usage of geared turbofans with large fan-drive gearboxes.

Thermal management systems typically have a first heat exchanger having passageways through which lubricating oil passes to be cooled by the fuel stream flowing past these passageways. This arrangement permits the lubricating oil to reject thermal energy to the fuel which beneficially facilitates engine operation. In some flight situations, the fuel reaches a thermal limit such that a portion of the lubricating oil is directed to an air-to-liquid heat exchanger where the heat therein is transferred to the air in the secondary airstream provided by the fan of the turbofan engine.

In one typical arrangement, a duct is provided in the fan cowling through which a portion of the airstream is diverted, such that the lubricating oil is cooled by the duct airstream. The fan airstream that is diverted to pass through the duct system flows at least in part through the air-to-liquid heat exchanger which needs to be large enough to provide adequate cooling for the most extreme “corner point” conditions encountered. These heat exchangers typically may require relatively large cross-sectional area ducts that may result in relatively significant thrust losses from the turbofan engine.

Accordingly, it is desirable to provide a thermal management system that reduces thrust losses and also reduces the volume required therefor for usage in the more compact spaces in advanced turbofan engines and yields substantial weight reduction in allowing smaller ducts and in reducing the massive mounts required to hold large ducts and heat exchanger assemblies during a hypothetical catastrophic engine failure.

### SUMMARY OF THE INVENTION

The thermal management system according to the present invention locates a separate engine heat exchanger and a generator heat exchanger into an engine nacelle pylon that is split by a bulkhead to provide independent control of both an engine cooling oil circuit and a generator cooling oil circuit. A variable exhaust nozzle is provided downstream of the engine heat exchanger exit and the generator heat exchanger exit as each has different thermal and heat rejection characteristics.

Independent operation of the variable exhaust nozzles provide independently controlled airflow from the engine heat exchanger and the generator heat exchanger such that intake air usage for each is minimized while maximum thrust is produced in response to the current generator load and engine heat rejection condition.

The present invention therefore provides a thermal management system that reduces thrust losses and also reduces the volume required therefor for usage in the more compact spaces in advanced turbofan engines.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1A is a general partial fragmentary view of an exemplary turbo fan engine embodiment for use with the present invention;

FIG. 1B is a longitudinal sectional view of the gas turbine engine illustrating heat exchanger locations therein;

FIG. 1C is a rear partially fragmented perspective view of the gas turbine engine;

FIG. 1D is an expanded partial fragmentary view of an engine pylon including separate engine heat exchanger and generator heat exchangers therein;

FIG. 2 is a schematic block diagram view of the thermal management system according to the present invention;

FIG. 3 is a longitudinal top sectional view of one embodiment of the pylon;

FIG. 4 is a longitudinal top sectional view of another embodiment of the pylon with a louvered intake arrangement; and

FIG. 5 is a longitudinal top sectional view of another embodiment of the pylon with a variable intake arrangement.

### DETAILED DESCRIPTION OF THE PREFERRED EMBODIMENT

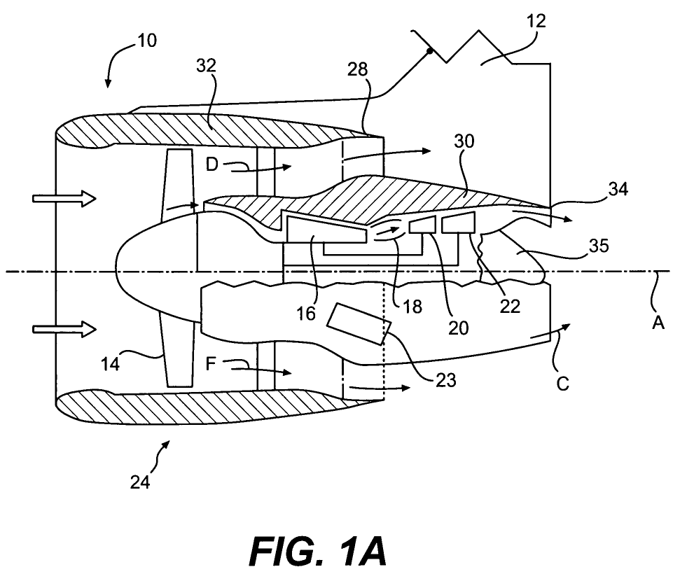

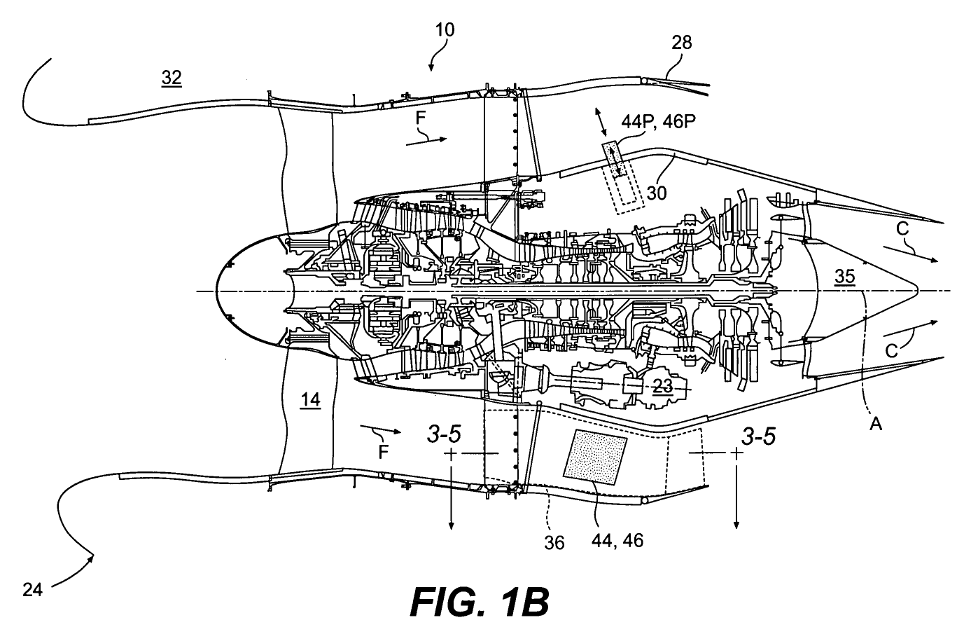

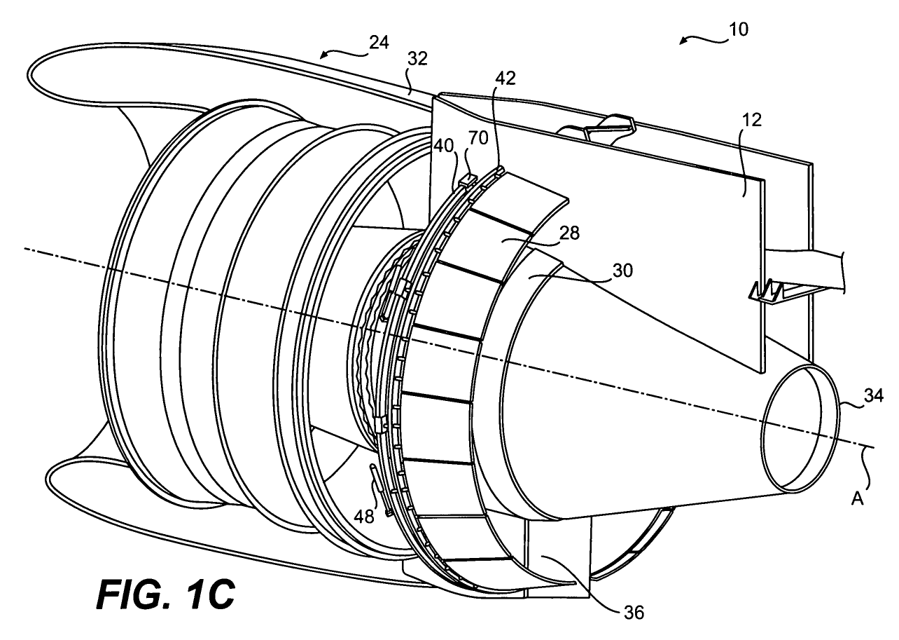

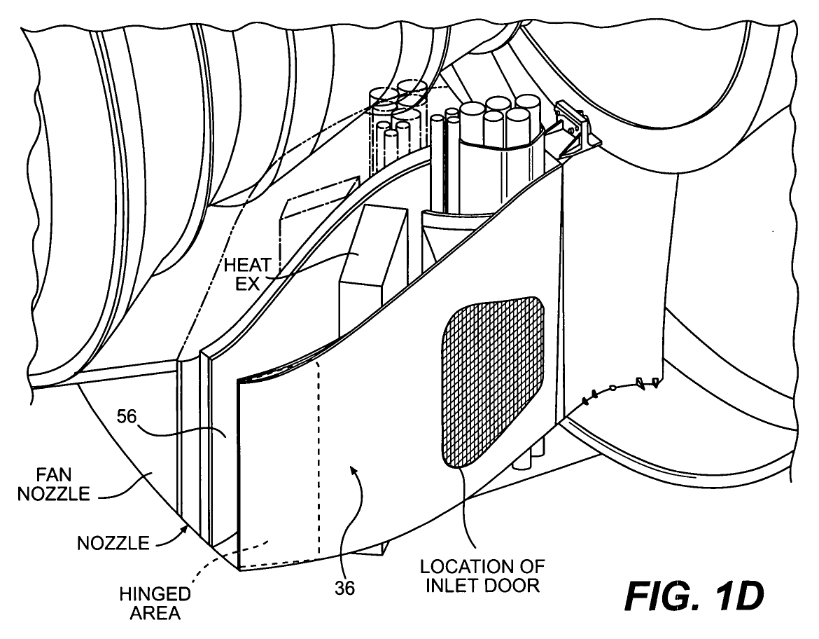

FIG. 1A illustrates a general partial fragmentary view of a gas turbofan engine 10 suspended from an engine pylon 12 as typical of an aircraft designed for subsonic operation. The engine 10 is preferably a high-bypass turbofan aircraft engine. The engine 10 typically includes in serial flow communication a fan 14 with a low pressure compressor, a high pressure compressor 16, an annular combustor 18, a high pressure turbine 20, and a low pressure turbine 22. Preferably, a generator system 23 is also driven by the engine 10.

During operation, air is pressurized in the compressor and mixed with fuel in the combustor for generating hot combustion gases which flow through the high and low pressure turbines that extract energy therefrom. The high pressure turbine powers the compressor through a shaft therebetween, and the low pressure turbine powers the fan through another shaft therebetween.

The exemplary turbofan engine 10 is in the form of a high bypass ratio engine mounted within a nacelle assembly 24 in which most of the air pressurized by the fan bypasses the core engine itself for generating propulsion thrust. The fan air F is preferably discharged from the engine 10 through a fan area nozzle 28 defined radially between a core nacelle 30 and a fan nacelle 32. The core exhaust gases C are discharged from the core engine through a core exhaust nozzle 34 defined between the core nacelle 30 and a center plug 35 disposed coaxially therein around an engine longitudinal centerline axis A of the engine 10 and nacelle assembly 24.

A pylon 36 is preferably located between the core nacelle 30 and the fan nacelle 32 (also illustrated in FIG. 1C). The pylon 36 is preferably a lower bifurcation, however, other types of pylons at various radial locations may likewise be usable with the present invention.

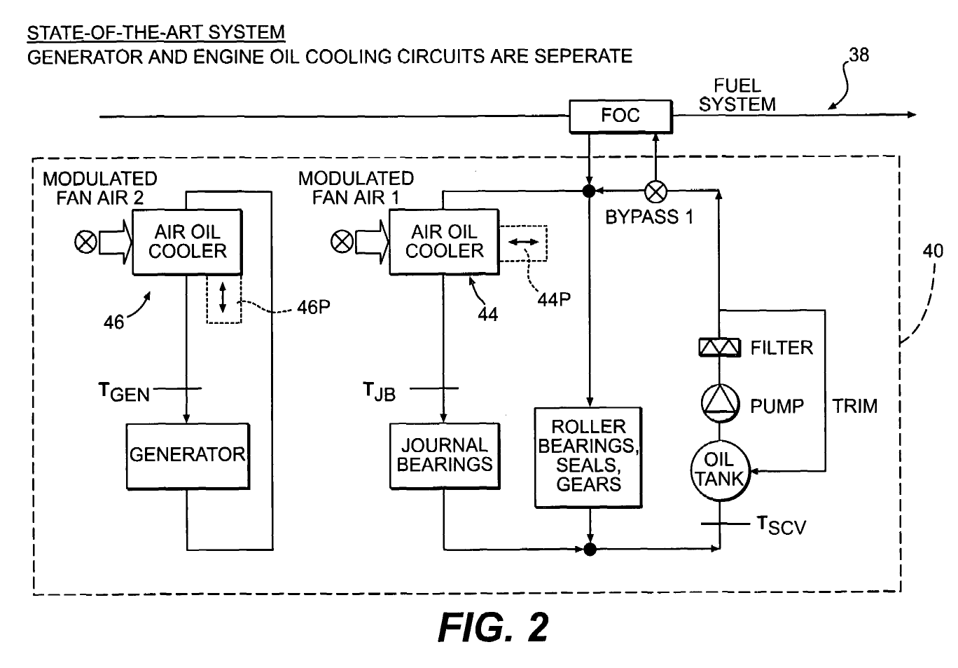

Referring to FIG. 2, a thermal management system 38 preferably communicates with a heat exchanger system 40 located at least partially within the nacelle assembly 24. The heat exchanger system 40 includes an engine heat exchanger 44 in communication with an engine cooling circuit and a generator heat exchanger 46 in communication with a generator cooling circuit. The engine heat exchanger 44 most preferably includes a peaking heat exchanger used only rarely in the most severe and rare high temperature conditions 44P. The generator heat exchanger 46 also most preferably includes a “peaking” heat exchanger 44G or “peaker.” The peaking heat exchangers 44P, 46P are preferably mounted within the core nacelle 30 and are each may be independently movable between a retracted position and an extended position relative to the core nacelle 30 (FIG. 1B). It should be understood that the thermal management system 38 may be utilized with or without the peaking heat exchangers 44P, 46P which operate to supplement their associated heat exchangers 44, 46.

The pylon-located engine heat exchanger 44 and the generator heat exchanger 46 are preferably sized for “typical” cooling loads while the peaker heat exchangers 44P, 46P are used for “corner point” conditions which allows for the smallest size and most effective operation of the engine heat exchanger 44 and generator heat exchanger 46 which enables the pylon to be reasonable in size and thereby provide the most fuel efficient operation of the engine in general. The thermal management system 38 is beneficial to the engines and aircraft which have relatively high heat rejection challenges while exploiting the relatively wide variation in heat loads and fuel heat sink capacity.

The thermal management system 38 preferably communicates “typical day” heat from the engine system and the generator system to the respective engine heat exchanger 44 and generator heat exchanger 46. The thermal management system 38 handles ground idle heat from the generator system with the peaking heat exchangers 44P, 46P. The peaking heat exchangers 44P, 46P are the third layer of the thermal management system 38 and are utilized relatively rarely except for corner point conditions—at ground idle it is typically fully deployed, but may also be partially deployed at other conditions to achieve efficiency and maintain the slenderness of heat exchanger pylon. The peaking heat exchangers 44P, 46P are preferably made to be exceedingly efficient at ground idle by making their front face of the peaking heat exchanger 44P, 46P will be exposed directly to fan total pressure—without inlet losses or exhaust duct losses. The peaking heat exchangers 44P, 46P may typically be closed from 90% to 99% of a flight depending on the packaging challenge associated with the pylon 36. That is, the peaking heat exchangers 44P, 46P deployment frequencies might be traded-off versus the size of the pylon 36 that contains the engine heat exchanger 44 and the generator heat exchanger 46.

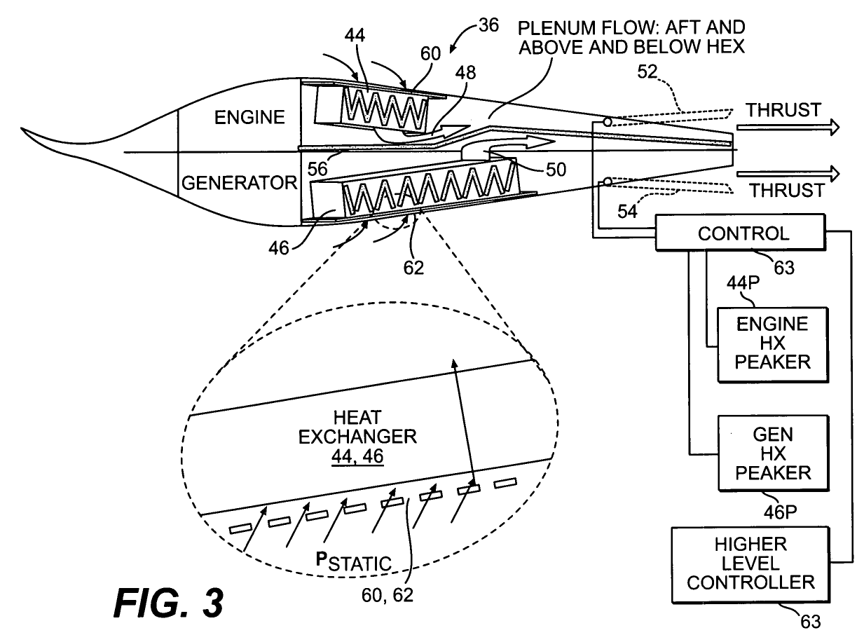

Referring to FIG. 3, the heat rejected from the engine heat exchanger 44 and the generator heat exchanger 46 are utilized to produce thrust. The heated air downstream of the engine heat exchanger 44 and the generator heat exchanger 46 expands and exits a respective engine heat exchanger exit 48 and a generator heat exchanger exit 50 such that thrust is generated therefrom. Preferably, a variable nozzle 52, 54 is provided downstream of each of the engine heat exchanger exit 48 and the generator heat exchanger exit 50 as each has different and independent thermal and heat rejection characteristics.

A baffle 56 separates the airflow from the engine heat exchanger 44 and the airflow from the generator heat exchanger 46. It should be understood that various baffles and bulkheads of various shapes may be utilized to facilitate control of the separate airflows. The engine heat exchanger airflow from the engine heat exchanger exit 48 and the generator heat exchanger airflow generator heat exchanger exit 50 is controlled by the respective engine heat exchanger variable nozzle 52 and the generator heat exchanger variable nozzle 54. Thermally independent operation of the variable nozzles 52, 54 independently control airflow from the engine heat exchanger 44 and the generator heat exchanger 46 such that fan intake air is minimized and maximum thrust is produced in response to the current generator load and engine heat rejection conditions.

The pylon 36 contains the engine heat exchanger 44 and generator heat exchanger 46 which are separated by the baffle 56. The engine heat exchanger exit 48 and the generator heat exchanger exit 50 are located on opposite sides of the baffle 56 to define the separate engine heat exchanger airflow from the engine heat exchanger inlet area 60 to the engine heat exchanger exit 48 and the generator heat exchanger airflow from the generator heat exchanger inlet area 62 to the generator heat exchanger exit 50 such that the airflows are separately controlled by the respective engine heat exchanger variable nozzle 52 and the generator heat exchanger variable nozzle 54. Preferably, the engine heat exchanger variable nozzle 52 and the generator heat exchanger variable nozzle 54 are operated in response to a thermal management system controller 63 which also preferably controls operation of the pod heat exchangers 44P, 46P. Preferably, the engine heat exchanger variable nozzle 52 and the generator heat exchanger variable nozzle 54 are operated to maintain a constant temperature or otherwise selected temperature at the engine heat exchanger exit 48 and the generator heat exchanger exit 50.

Mounting the engine heat exchanger exit 48 and the generator heat exchanger exit 50 on the pylon 36 is desirable from a system weight standpoint. Preferably, a coupling arrangement may be provided to permit disconnect of the coolant conduits lines such that the heat exchangers stay with the nacelle 36 when the engine 10 is changed out.

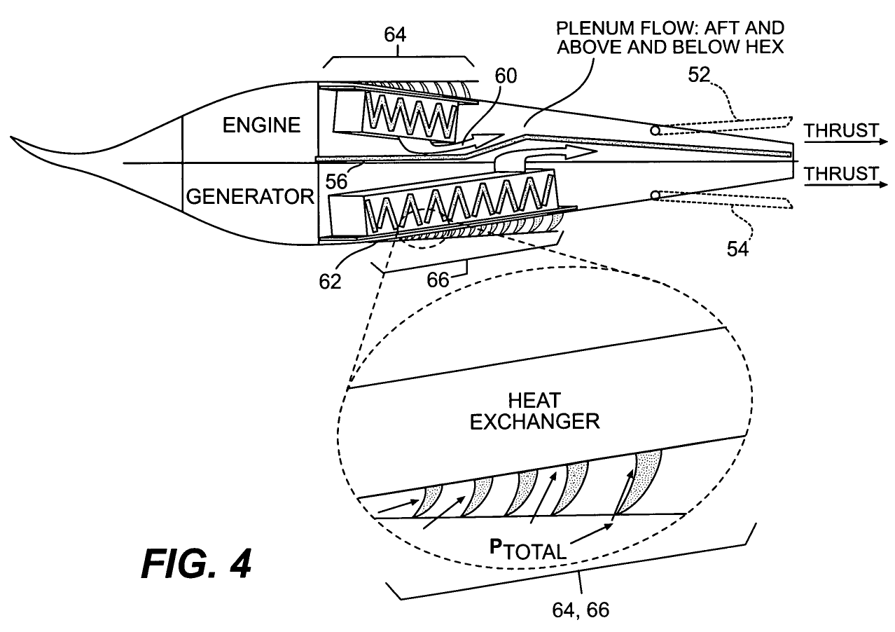

Referring to FIG. 4, the engine heat exchanger inlet area 60 and the generator heat exchanger inlet area 62 each include a louver systems 64, 66 to minimized the heat exchanger size when using only the static pressure (Pstatic) in the fan duct at the face of the heat exchangers 44, 46. The louver systems 64, 66 receive at least a portion of the total pressure head (Ptotal). The louver systems 64, 66 are preferably empirically-designed turning vanes which most preferably have a variation of height to minimize the “shadowing” effect created by each upstream louver relative the next downstream louver. Preferably, the louver systems 64, 66 may alternatively be variable and controlled in response to the thermal management system controller 63.

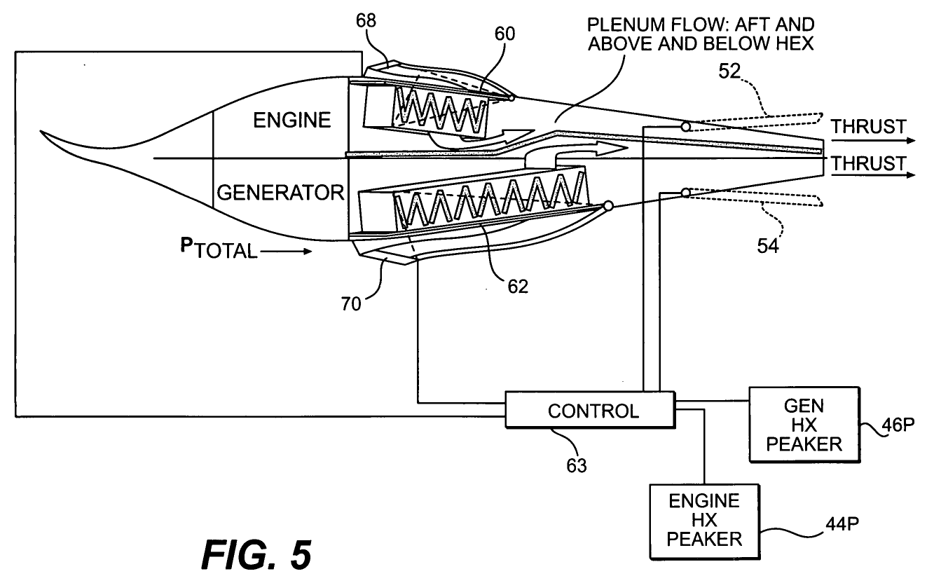

Referring to FIG. 5, the engine heat exchanger inlet area 60 and the generator heat exchanger inlet area 62 each include a variable inlet scoop system 68, 70. The variable inlet scoop systems 68, 70 are varied in response to the amount of air flowing through the engine heat exchanger 44 and the generator heat exchanger 46 in conjunction with the engine heat exchanger variable nozzle 52 and the generator heat exchanger variable nozzle 54 in response to the thermal management system controller 63 to prevent spilling of flow and the associated mixing loss. Therefore, although a system weight increase due the incorporation of the variable inlet scoop systems 68, 70 and actuators may occur, it is offset by the reduction in the heat exchanger size. In addition, a fuel consumption improvement results as the variable inlet scoop systems 68, 70 are preferably managed at all flight conditions by the controller 63 such that there is a minimum fan duct drag loss and a maximum net thrust production.

It should be understood that relative positional terms such as “forward,” “aft,” “upper,” “lower,” “above,” “below,” and the like are with reference to the normal operational attitude of the vehicle and should not be considered otherwise limiting.

It should be understood that although a particular component arrangement is disclosed in the illustrated embodiment, other arrangements will benefit from the instant invention.

Although particular step sequences are shown, described, and claimed, it should be understood that steps may be performed in any order, separated or combined unless otherwise indicated and will still benefit from the present invention.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A gas turbine engine comprising:
an engine nacelle assembly defining a first flow path between a first inlet and a first outlet;
a heat exchanger within said first flow path; and
a variable exhaust nozzle downstream of said first outlet.

2. The gas turbine engine as recited in claim 1, wherein said engine nacelle assembly further comprises:
a second flow path between a second inlet and a second outlet;
a second heat exchanger within said second flow path; and
a variable exhaust nozzle downstream of said second outlet.

3. The gas turbine engine as recited in claim 2, further comprising:
a baffle between said first flow path and said second flow path to separate a first airflow through the first flow path and a second airflow through the second flow path.

4. The gas turbine engine as recited in claim 1, wherein said engine nacelle assembly comprises a pylon between a first nacelle and a second nacelle, said pylon defining said first flow path and said second flow path.

5. The gas turbine engine as recited in claim 4, wherein said pylon includes a lower bifurcation.

6. The gas turbine engine as recited in claim 1, wherein said first inlet includes a louver system.

7. The gas turbine engine as recited in claim 1, wherein said first inlet includes a variable inlet scoop.

8. A thermal management system for a gas turbine engine comprising:
a first nacelle;
a second nacelle;
a pylon between said first nacelle and said second nacelle, said pylon defining a first flow path between a first inlet and a first outlet and a second flow path between a second inlet and a second outlet;
a first liquid-air heat exchanger within said first flow path;
a first liquid cooling circuit in communication with said first heat exchanger;
a second liquid-air heat exchanger within said second flow path; and
a second liquid cooling circuit in communication with said second heat exchanger.

9. The system as recited in claim 8, wherein said first cooling circuit includes an engine oil cooling circuit.

10. The system as recited in claim 9, wherein said second cooling circuit includes a generator oil cooling circuit separate from said engine oil cooling circuit.

11. The system as recited in claim 8, wherein said first nacelle includes a fan nacelle.

12. The system as recited in claim 11, wherein said second nacelle includes a core nacelle.

13. The system as recited in claim 8, wherein said pylon includes a lower bifurcation.

14. The system as recited in claim 8, wherein said first heat exchanger is mounted opposite said second heat exchanger on first and second lateral sides of said pylon, said first flow path separated from said second flow path by a baffle.

15. A method of thermal management for a gas turbine engine comprising the steps of:
(A) locating a first heat exchanger and a second heat exchanger within an engine nacelle assembly;
(B) communicating a first airflow over the first heat exchanger and a second airflow over the second heat exchanger; and
(C) producing thrust from the first airflow and the second airflow.

16. A method as recited in claim 15, wherein said step (B) further comprises:
(a) communicating the first airflow over the first heat exchanger, the first heat exchanger in communication with an engine cooling circuit; and
(b) communicating the second airflow over the second heat exchanger, the second heat exchanger in communication with a generator cooling circuit separate from the engine cooling circuit and the first airflow separate from the second airflow.

17. A method as recited in claim 15, wherein said step (C) further comprises:
(a) communicating the first airflow into a first inlet to a pylon of the nacelle assembly, the pylon between a fan nacelle and a core nacelle; and
(b) communicating the second airflow into a second inlet to the pylon.

18. A method as recited in claim 15, wherein said step (C) further comprises:
(a) controlling a first variable nozzle to control a thrust generated by the first airflow; and
(b) controlling a second variable nozzle independently of the first variable nozzle to control a thrust generated by the second airflow.
